(19) United States
(12) Patent Application Publication
(10) Pub. No.: US 2024/0157352 A1
(43) Pub. Date: May 16, 2024

(54) Inorganic Sorbent for Extraction of Lithium from Lithium-Containing Brines

(71) Applicants: Pavel Kudryavtsev, Rehovot (IL); Nikolai Kudriavtsev, Holon (IL); Iliya Kudryavtsev, Odintsovo (IL)

(72) Inventors: Pavel Kudryavtsev, Rehovot (IL); Nikolai Kudriavtsev, Holon (IL); Iliya Kudryavtsev, Odintsovo (IL)

(21) Appl. No.: 17/979,999

(22) Filed: Nov. 3, 2022

(51) Int. Cl. B01J 39/10; B01J 39/02; B01J 47/014; C01G 45/12

(52) U.S. Cl. CPC B01J 39/10; B01J 39/02; B01J 47/014; C01G 45/1221; C01P 2002/32; C01P 2002/50; C01P 2002/74; C01P 2004/60

(57) ABSTRACT

An inorganic sorbent for lithium extraction from lithium-containing natural and technological brines, which have low concentration of lithium. The sorbent has high selectivity for lithium in ion-exchange lithium-extraction processes and is expressed by the following general formula:

HₓMnO_{y}·zAl₂O₃·nH₂O;

wherein:
“x” is a number ranging from 0.5 to 2.0,
“y” is a number ranging from 2.0 to 3.0,
“z” is a number ranging from 0.01 to 0.1, and
“n” is a number ranging from 1.0 to 2.0.

### FIELD OF ART

The present invention relates to an inorganic sorbent for lithium extraction from lithium-containing natural and technological brines and, in particular, to an ion-exchange material that possesses high selectivity to lithium in ion-exchange lithium-extraction processes.

### DESCRIPTION OF THE PRIOR ART

Historically, lithium is extracted from two sources: continental brines and minerals of hard rocks. At the present time, lithium finds use in the production of glass, ceramics, medical substances, and metallurgical products, as well as in such fields as nuclear energy, aviation, etc. Demand for lithium will certainly grow when vehicles become greener and electricity becomes cleaner. World sales of lithium salts currently amount to more than $1 billion a year because this element has become an important component of lithium-ion batteries, which now feed everything from electric cars to power tools and smartphones.

According to forecasts, over the next eight years, the demand for lithium will increase by more than 300%. Nevertheless, whenever larger electric companies expand the power of solar energy, demanding the storage of high-density energy Li-ion batteries, the demand for lithium skyrockets. For example, Duke Energy (one of the world leaders in energy production) currently stopped the proposed nuclear power plant in Florida and instead planned to invest $6 billion in solar and battery infrastructures. The ever-increasing demand for batteries and the need to store high-density energy created an acute dependence of many industries of the world on lithium, which triggered a global search for new lithium sources.

Nowadays, hydro-mineral raw materials have gradually become the main source of lithium. The main attention is on developing methods for processing lithium-containing hydromineral raw materials. The most commonly used method is extracting lithium from natural brines by precipitation of sparingly soluble salts. However, from an ecological point of view, more promising are sorption methods of extraction of lithium from natural and technological brines that are poor in lithium content. Because of the complexity of the composition of salts contained in hydromineral raw materials, the most promising method for the recovery of lithium is the use of highly selective inorganic ion-exchange materials.

Sorbents and methods of obtaining sorbents for extraction of lithium from lithium-containing natural and technological brines are known in the art.

For example, U.S. Pat. No. 11,260,366 was granted on Mar. 1, 2022, to P. Kudryavtsev. et al. discloses a method of obtaining inorganic sorbents for the extraction of lithium from lithium-containing natural and technological brines by a) obtaining a first non-stoichiometric compound as a precipitate of hydrated mixed oxide of manganese (II) and aluminum (III) by contacting a soluble manganese (II) salt with an alkali solution in the presence of at least one aluminum (III) salt; b) obtaining a second non-stoichiometric compound, which is a precipitate of hydrated mixed oxide of manganese(III), manganese(IV) and aluminum (III) by oxidizing the first non-stoichiometric compound with the use of a solution of an oxidizing agent; c) isolating the obtained second non-stoichiometric compound to obtain a wet paste of hydrated mixed oxide of manganese(III), manganese(IV) and aluminum (III); d) obtaining a third non-stoichiometric compound by granulating and simultaneously drying the obtained wet paste of hydrated mixed oxide of manganese(III), manganese(IV) and aluminum (III); e) obtaining a fourth non-stoichiometric compound by converting the obtained third non-stoichiometric compound into a lithium-form by passing therethrough a lithium-containing solution in an ion-exchange column; f) calcining the obtained fourth non-stoichiometric compound to obtain a fifth non-stoichiometric compound which comprises a mixed oxide of lithium, manganese(III), manganese(IV) and aluminum (III); and g) obtaining a sixth non-stoichiometric compound by converting the obtained fifth non-stoichiometric compound into a hydrogen-form of inorganic ion-exchanger by treating the fifth non-stoichiometric compound with an acid solution.

U.S. Pat. No. 10,434,497 granted on Oct. 8, 2019 to P. Kudryavtsev, et al. discloses a method of producing inorganic sorbents for extracting lithium from lithium-containing natural and technological brines by: contacting a soluble niobate (V) with an acid in the presence of at least one zirconium (IV) salt to obtain a precipitate of a mixed hydrated niobium and zirconium oxide, which is a non-stoichiometric compound; granulating the obtained precipitate of a mixed hydrated niobium and zirconium oxide by freezing with subsequent defreezing to obtain a granulated mixed hydrated niobium and zirconium oxide; converting the obtained granulated mixed hydrated niobium and zirconium oxide into a Li-form of the granulated mixed hydrated niobium and zirconium oxide by treating the granulated mixed hydrated niobium and zirconium oxide with a lithium-containing compound selected from the group consisting of a solution of lithium hydroxide LiOH and a solution of Li₂CO₃; calcining the Li-form of the granulated mixed hydrated niobium and zirconium oxide to obtain a granulated mixed lithium, niobium, and zirconium oxide, which is a tripled mixed oxide, which is a Li-form of an inorganic ion-exchanger; and converting the obtained granulated mixed lithium, niobium, and zirconium oxide to an ion-exchanger in an H-form by treating the granulated mixed lithium, niobium, and zirconium oxide with an acid solution.

Another method for extracting lithium from lithium-containing natural and industrial brines is disclosed in now-pending U.S. patent application Ser. No. 17/688,005 filed on Mar. 7, 2022, by P. Kudryavtsev et al. According to this application, the method relates to manufacturing inorganic ion exchanger represented by the following general formula: HₐNbO_{(2.5+0.5·a)}·bLi₂OcWO₃dH₂O, wherein: “a” is a number ranging from 0.5 to 2.0, “b” is a number ranging from 0.01 to 0.5, “c” is a number ranging from 0.01 to 0.2, and “d” is a number ranging from 0.1 to 2.0. The method consists of the following steps: interacting a soluble niobate (V) with an acid that contains at least one soluble tungsten (VI) compound, thus forming a hydrated niobium (V) oxide and a hydrated tungsten (VI) oxide, which co-precipitate and form a mixed hydrated niobium (V) and tungsten (VI) oxide; granulating the mixed hydrated niobium (V) and tungsten (VI) oxide by freezing with subsequent defreezing, thus obtaining a granulated mixed hydrated niobium (V) and tungsten (VI) oxide; converting the granulated mixed hydrated niobium (V) and tungsten (VI) oxide into a lithium form of a hydrated mixed oxide by treating thereof with a lithium-containing compound selected from the group consisting of aqueous solutions of lithium hydroxide and lithium carbonate; calcining the lithium form of the granulated mixed hydrated niobium (V) and tungsten (VI) oxide to obtain a mixed granulated tripled lithium, niobium (V) and tungsten (VI) oxide, which constitutes a lithium-form of the inorganic ion-exchanger; and converting the lithium-form of the inorganic ion-exchanger into an H-form of the inorganic ion-exchanger by treating thereof with an acid solution.

### SUMMARY OF THE INVENTION

The present invention relates to an inorganic sorbent for lithium extraction from lithium-containing natural and technological brines and, in particular, to an ion-exchange material that possesses high selectivity to lithium in ion-exchange lithium-extraction processes. In an H-form, the lithium-extraction inorganic sorbent of the present invention (hereinafter referred to merely as an “inorganic sorbent”) is represented by the following general formula:

HₓMnO_{y}·zAl₂O₃·nH₂O;

wherein:
“x” is a number ranging from 0.5 to 2.0,
“y” is a number ranging from 2.0 to 3.0,
“z” is a number ranging from 0.01 to 0.1, and
“n” is a number ranging from 1.0 to 2.0.

### BRIEF DESCRIPTION OF DRAWINGS

FIG. 1 is a graph illustrating the sorption capacity for lithium (E_{Li}—Curve 1), sorption capacity for sodium (E_{Na}—Curve 2), and separation factor of lithium and sodium ions (P_{Li,Na}—Curve 3) on the content of aluminum oxide in the sorbent (n is a molar ratio Al₂O₃/MnOₓ in the content of the inorganic sorbent).

FIG. 2 is a graph showing the dependence of the ion-exchange capacity for lithium obtained by sorption from a 0.1 N LiCl solution (Curve 1) and the hydromechanical stability of the sorbent (Curve 2) on the Mn²⁺/MnO₄⁻ molar ratio.

FIG. 3 is a graph showing the dependence of the obtained molar ratio Al₂O/MnOₓ m (Curve 1) and K/MnOₓ (Curve 3) in the solid phase on the Ph of the precipitated mixed hydrated manganese(III), manganese(IV), and aluminum (III) oxide. Curve 2 is the Al₂O₃/MnOₓ molar ratio given at synthesis.

FIG. 4 is a graph showing the dependence of the sorption capacity for lithium (Curve 1—sorption of lithium from a 0.1 N LiCl solution) and the hydromechanical stability of the sorbent (Curve 2) on the precipitate pH.

FIG. 5 is a graph showing heat treatment temperature's effect on the material's synthesis and its sorption-selective properties. Eₒᵥₑᵣₐₗₗ is the total ion exchange capacity of the sorbent. E_{Li} is the selective capacity of the sorbent for lithium. E_{Na} is the selective capacity of the sorbent for sodium; P_{Li/Na} is the separation factor of lithium and sodium.

FIG. 6 is a graph showing the effect of heat treatment temperature on the hydromechanical stability of the sorbent.

FIG. 7 is a graph showing dependence of the capacity (Eᵢ) of the sorbent, during sorption of a corresponding ion, on the ion diameter (Dᵢ) (Curves 1,2,3,4,5,6) and dependence of the sorbent capacity derivative

$$( - \frac{d {E}_{i}}{d {D}_{i}} ) )$$

with respect to the diameter of the ion being sorbed on the ion diameter.

FIG. 8 shows the dependence of the relative intensity of I/Iₘₐₓ on the heat treatment temperature, where I/Iₘₐₓ for each phase is a ratio of the intensity of one of the lines to its maximum value recorded on the X-ray patterns obtained for a sample being tested, and T is the heat treatment temperature (° C.); Curves 1 and 2 correspond to relative intensities for the birnessite phase line in the X-ray pattern with d=7.12 Å; Curves 3 and 4 correspond to relative intensities for the spinel phase line in the X-ray pattern with d=4.72 Å; Curves 1 and 3 correspond to samples with z=0.019; and Curves 2 and 4 correspond to samples with z=0.073.

FIG. 9 is a graph showing the effect of sodium (Na⁺), magnesium (Mg²⁺), and calcium (Ca²⁺) cation concentrations in a lithium-containing brine on sorbent selective capacity for lithium.

FIG. 10 is a graph showing the effect of the concentration of ions of tetraborate (B₄O₇²⁻) and iodine (I⁻) in the lithium-containing brine on sorbent selective capacity for lithium.

### DETAILED DESCRIPTION OF THE INVENTION

The present invention relates to an inorganic sorbent for lithium extraction from lithium-containing natural and technological brines and, in particular, to an ion-exchange material that possesses high selectivity to lithium in ion-exchange lithium-extraction processes.

The term “brines” used in the present patent specification covers any natural or technological solutions containing lithium.

The inorganic sorbent of the invention can be used to extract lithium from weakly acidic and slightly alkaline solutions with a high content of sodium ions and ions of other alkali and alkaline earth metals. The inorganic sorbent of the invention is an ion sieve capable of selectively absorbing lithium ions from complex natural and technological solutions in a high salt background, consisting of various salts of alkali and alkaline earth metals. The inorganic sorbent of the invention is obtained by a method, which is carried out in the presence of oxidizing, reducing, modifying agents, and components forming a specific crystal structure.

Ionic sieves are inorganic ion-exchange sorbents that exhibit the so-called ion-sieve effect, which is the effect of separating ions in a solution according to the difference in their ionic radii. Dimension positions in the crystal structure of the material corresponding to certain ions, and ions of a larger size cannot enter unspecified positions. Thus, the ion-sieve effect provides high selectivity in the sieve-effect sorbents. A unique feature of the inorganic ion-exchange sorbent of the present invention is its specific structure that provides high selectivity, especially for lithium ions.

It is important to note that in the context of the present patent specification, the term “hydrated mixed oxide”, e.g., of manganese(III), manganese(IV), and aluminum (III) oxide”, does not mean a mechanical mixture of hydrated manganese(III) and (IV) oxides with hydrated aluminum oxide, but rather means a chemical compound of non-stoichiometric composition.

The purpose of the invention is to improve the sorbent's exchange capacity and selectivity regarding lithium ions.

The sorbent of the invention is obtained by the method, which is described later, in an H-form and is expressed by the following formula:

In the H-form, the inorganic sorbent is represented by the following formula: HₓMnO_{y}·zAl₂O₃·nH₂O. where “x” is a number ranging from 0.5 to 2.0, “y” is a number ranging from 2.0 to 3.0, “z” is a number ranging from 0.01 to 0.1, and “n” is a number ranging from 1.0 to 2.0. In this case, the parameter “y” and “n” are parameters, the values of which depend on the parameter “x” and “z” and the conditions of material synthesis.

The value of the parameter “n” also depends on the drying conditions of the material samples in the H-form before measuring the water content in the material. Typically, the water content in the H-form of the sorbent is determined after drying the material at room temperature and atmospheric pressure to constant weight. The values of “n” obtained in the experiments conducted by the inventors are shown in Table 1. If the parameter “x” has a value lower than 0.5, the exchange capacity of the sorbent will be too low to the extent that it would be economically unprofitable to use such a composition in the lithium extraction processes. If the parameter “x” has a value higher than 2.0, the sorbent will have very low chemical stability, and the use of such a composition will become improper for lithium extraction. If the parameter “z” has a value lower than 0.01, then 0.3, and if the parameter “z” exceeds 0.01, then the sorbent will have low exchange capacity and selectivity and becomes unsuitable for use in the aforementioned processes.

In the Li-form, the lithium-extraction inorganic sorbent of the present invention is represented by the following formula: LiₓMnO_{y}·zAl₂O₃, the values of x, y, and z are the same as given above.

For use in the lithium-extraction process, it is preferable to have the inorganic ion-exchanger of the invention in the form of solid particles with dimensions ranging from 0.1 to 2.0 mm. On the one hand, with the size of particles less than 0.1 mm, it will be difficult to handle the sorbent in ion-exchange columns because of the passage of the particles into the lower part of the column through the cells of the filtering partitions. In other words, the size of particles exceeding 2.0 mm will delay the ion-exchange rate because of the retardation of diffusion of lithium in the sorbent particles that occur in the ion-exchange process.

As mentioned above, the inorganic polymeric aqua-oxo-hydroxo complex is a complex of niobium and tungsten. It is a mixed polynuclear complex with a total ion exchange capacity of at least 2.8 meq/g and an ion-exchange capacity specifically to lithium of at least 2.5 meq/g.

What is meant by the term “mixed polynuclear complex” in the context of the present patent application are polynuclear coordination compounds, in the molecules of which there are several metal atoms surrounded by ligands and linked to each other through bridging groups. Bi- and trinuclear coordination compounds are the most studied. When the number of metal atoms is large, such compounds are called coordination or metal-containing polymers, metal polymers. The ratio between polynuclear compounds and coordination polymers is the same as between monomers, oligomers, and polymers in carbon chain high molecular weight compounds. Polynuclear compounds are sometimes referred to as compounds containing cells of directly bonded metal atoms, commonly referred to as clusters. There are homo- and heterometallic polynuclear compounds. The materials that are the subject of this application are cross-linked polymeric polynuclear bimetallic coordination compounds.

More detailed information about a mixed polynuclear complex may be found in Haiduc J., “Polymeric Coordination Compounds”, Russian Chemical Reviews, 1961, 30 (9), pp. 498-526, and Bunker, Bruce C.; Casey, William H. The aqueous chemistry of oxides [First edition], ISBN 9780199384259, Oxford University Press, 2016, 604 p.

Examples of sorbents of various compositions obtained by the method of the invention in the H-form are given below in Table 1 (Li-forms are similar and, therefore, not included).

TABLE 1
Influence of Preparation Conditions on the
Composition and Properties of Sorbents

| | | | | | The | Selec- | Coeffi- |
|---|---|---|---|---|---|---|---|
| | | | | | average | tive | cient of |
| Synthesis | | | | | degree | capacity | separation |
| temper- | | | | | of Mn | for Li⁺, | of ions of |
| ature, | | | | | oxi- | (E_{Li}, | Li⁺ and Na⁺, |
| ° C. | x | y | z | n | dation | mol/kg) | (P_{Li, Na}) |
| 650 | 0.19 | 1.65 | 0.000 | 0.51 | 3.10 | 0.85 | 1.4 · 10⁴ |
| 600 | 0.20 | 1.70 | 0.019 | 0.51 | 3.20 | 0.91 | 4.2 · 10⁴ |
| 550 | 0.22 | 1.76 | 0.035 | 0.52 | 3.30 | 1.05 | 9.2 · 10⁴ |
| 500 | 0.23 | 1.81 | 0.050 | 0.52 | 3.40 | 1.34 | 1.8 · 10⁵ |
| 450 | 0.27 | 1.93 | 0.061 | 0.53 | 3.60 | 1.95 | 2.7 · 10⁵ |
| 450 | 0.27 | 1.73 | 0.073 | 0.51 | 3.20 | 2.22 | 3.4 · 10⁵ |
| 450 | 0.26 | 1.73 | 0.085 | 0.51 | 3.20 | 2.18 | 2.3 · 10⁵ |
| 450 | 0.27 | 1.84 | 0.100 | 0.52 | 3.40 | 1.76 | 1.4 · 10⁵ |
| 450 | 0.26 | 1.78 | 0.129 | 0.52 | 3.30 | 1.25 | 5.6 · 10⁴ |
| 450 | 0.26 | 1.93 | 0.153 | 0.53 | 3.60 | 0.98 | 4.4 · 10⁴ |
| 400 | 0.24 | 1.87 | 0.180 | 0.53 | 3.50 | 0.76 | 3.2 · 10⁴ |
| 350 | 0.23 | 1.91 | 0.212 | 0.53 | 3.60 | 0.72 | 2.8 · 10⁴ |
| 300 | 0.17 | 1.99 | 0.250 | 0.55 | 3.80 | 0.68 | 2.5 · 10⁴ |
| 250 | 0.12 | 1.99 | 0.300 | 0.55 | 3.85 | 0.57 | 1.1 · 10³ |

It can be seen from Table 1 that inorganic sorbents that have values of x, y, z, and n within the scope of the present invention reveal a better selective capacity for Li⁺ than those, which have values of x, y, z, and n beyond the scopes recommended For better understanding characteristic and properties of the inorganic lithium-extraction sorbent of the invention, it would be advantageous to familiarize yourself with a method suitable for the preparation of this sorbent. The aforementioned method is the subject of another invention disclosed in now-pending patent application Ser. No. 17/956,656 filed by the inventors herein on Sep. 29, 2022 and entitled “Method for Obtaining Inorganic Sorbent for Extraction of Lithium from Lithium-Containing Brines”.

As the above application is still pending and is not yet accessible to the public, the method is included herein with all details. The method, though, is beyond the scope of the present invention.

The inorganic sorbent of the invention is obtained by a method carried out in the presence of oxidizing, reducing, and modifying agents and components that form a predetermined crystalline structure.

At the initial stage of manufacturing, the sorbent of the invention has a crystalline structure similar to one in birnessite. The birnessite (nominally MnO₂·nH₂O) is a hydrous manganese dioxide mineral with a chemical formula of Na_{0.7}Ca_{0.3}Mn₇O₁₄·2.8H₂O. During heat treatment of the polymeric aqua-oxo-hydroxo complex of manganese(III), manganese(IV), aluminum, and lithium, a phase is formed that has a crystal structure of cubic lithium-manganese spinel. The influence of Al(III) ions on the transition of the birnessite phase to the spinel phase was studied in more detail on samples of materials containing various amounts of an Al₂O₃ additive and heat-treated at various temperatures and isothermal conditions.

The method consists of a plurality of sequential steps, which are the following: contacting a mixture of at least one soluble manganese (II) salt in an aqueous solution and at least one aluminum (III) salt in an aqueous solution with an alkali solution in a reaction container in a mother solution in the presence of an alkali metal permanganate to obtain a precipitate of a mixed hydrated manganese(III), manganese(IV), and aluminum (III) oxide, which is a non-stoichiometric compound; washing the obtained precipitate by decanting with deionized water to a certain content in the mother solution of the at least one alkali metal salt; discontinuing the decanting and settling the precipitate in the reaction container to a predetermined level; removing a transparent part of the mother solution to obtain a precipitate suspension in a residue of the mother solution; transferring the obtained precipitate of the precipitate suspension in the residue of the mother solution to a freezer container and freezing the precipitate to a solid frozen state for obtaining a mixed hydrated manganese(III), manganese(IV), and aluminum (III) oxide in an icy granular form having a surface; removing at least one alkali metal salt from the surface of the icy granular form; thawing the mixed hydrated manganese(III), manganese(IV), and aluminum (III) oxide to form a resulting granulated mixed hydrated manganese(III), manganese(IV), and aluminum (III) oxide and thawing the mother solution to form a thawed mother solution; separating the icy granular form from an excess of the thawed mother solution; converting the resulting granulated mixed hydrated manganese(III), manganese(IV), and aluminum (III) oxide into an H-form of the granulated mixed hydrated manganese(III), manganese(IV), and aluminum (III) oxide by treating thereof with a solution of an acid; converting the H-form of the granulated mixed hydrated manganese(III), manganese(IV), and aluminum (III) oxide into a Li-form of the granulated mixed hydrated manganese(III), manganese(IV), and aluminum (III) oxide by treating thereof with a solution of a lithium-containing compound; drying and calcining the Li-form of the granulated mixed hydrated manganese(III), manganese(IV), and aluminum (III) oxide to obtain a dehydrated granulated mixed manganese(III), manganese(IV), and aluminum (III) oxide, which contains in its composition four oxides and comprises a lithium-form of an inorganic ion-exchanger; and converting the obtained lithium-form of an inorganic ion exchanger into an H-form of the ion-exchanger by treating thereof with an acid solution.

The first step of the method consists of preparing a mixture of at least one soluble manganese (II) salt in an aqueous solution with at least one aluminum (III) salt in an aqueous solution with an alkali solution in a reaction container. This procedure is carried out in a mother solution in the presence of an alkali metal permanganate to obtain a precipitate of a mixed hydrated manganese(III), manganese(IV), and aluminum (III) oxide.

An alkali metal permanganate suitable for the purposes of the invention may be exemplified by potassium permanganate KMnO₄, sodium permanganate NaMnO₄, rubidium permanganate RbMnO₄, cesium permanganate CsMnO₄ and ammonium permanganate NH₄MnO₄.

The obtained precipitate constitutes a non-stoichiometric compound. The soluble manganese (II) salt may be represented, e.g., by MnSO₄, MnCl₂, Mn(NO₃)₂, Mn(Ac)₂, MnBr₂, or Mn(ClO₄)₂. The aluminum (III) salt may be represented, e.g., by Al₂(SO₄)₃, AlCl₃, Al(OH)Cl₂, Al(NO₃)₃, Al(Ac)₃, Al(ClO₄)₃, or AlBr₃. The alkali solution that contacts the mixture of the at least one soluble manganese salt (II) and the at least one aluminum salt (III) in the presence of an alkali metal permanganate is a hydroxide such as, e.g., NaOH, KOH, or NH₄OH.

In the aforementioned mixture of the aqueous solution of the at least one soluble manganese (II) salt and the aqueous solution of the at least one aluminum (III) salt, a molar ratio of manganese (II) to aluminum (III) is maintained in the range of 1:0.0 to 1:0.20.

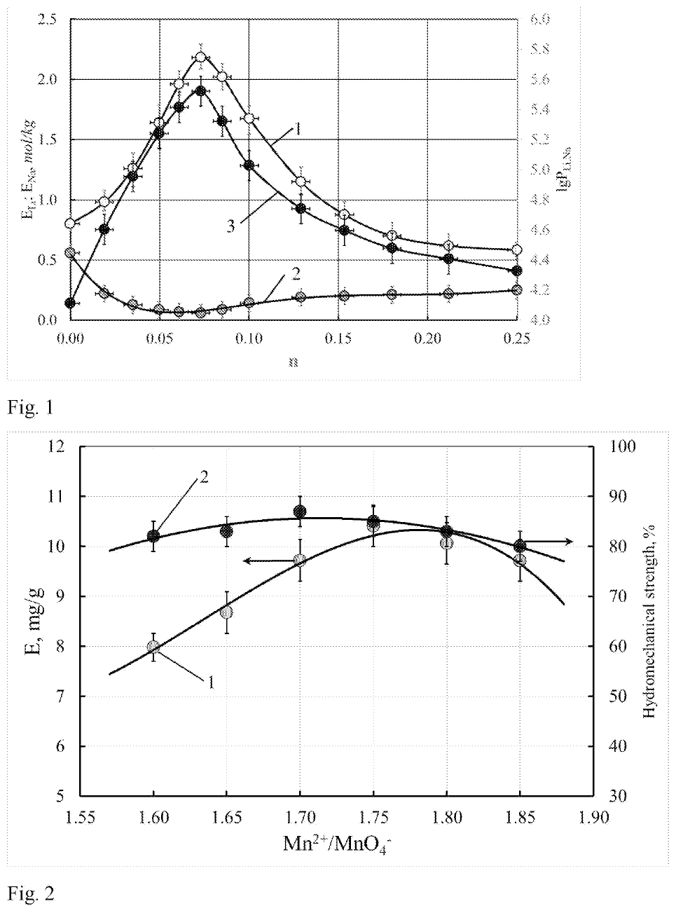

Such a range was chosen based on experiments conducted in studying the effect of additives shown in FIG. 1, which is a graph showing the dependence of the capacity for lithium (E_{Li}), sodium (E_{Na}), and the separation factor of lithium ions and sodium (P_{Li,Na}) on the content of alumina in the sorbent. In this drawing, n is Al₂O₃/MnOₓ and expresses a molar ratio of oxides Al₂O₃ to MnOx in the composition of the inorganic sorbent. The optimal value of n is 0.075±0.009.

Suppose the molar ratio of manganese (II) to aluminum (III) in the aforementioned mixture exceeds 1:0.20. In that case, the selective capacity of the sorbent for lithium will be lower than in the respective composition without the addition of an aluminum (III) salt.

The aforementioned first step of contacting the mixture of at least one soluble manganese salt (II) and at least one aluminum salt (III) with an alkali solution in the presence of an alkali metal permanganate is performed at a molar ratio of the soluble manganese (II) salt to the alkali metal permanganate in a ratio from 1:1 to 1:2.

Such a range was chosen based on experiments that studied the dependence of the ion-exchange capacity of the sorbent during the sorption of lithium from a 0.1 N LiCl solution and the hydromechanical stability of the sorbent on the Mn²⁺/MnO₄ molar ratio, shown in FIG. 2.

If this molar ratio is below 1:1, this may lead to insufficient oxidation of Mn(II) with alkali metal permanganate, and this, in turn, may lead to a decrease in the content of hydrated manganese(IV) oxide and to increase in the content of hydrated manganese(III) oxide in the resulting non-stoichiometric compound. As a result, the ion-exchange capacity and selectivity of the sorbent to lithium ions will be reduced. In some cases, the content of hydrated manganese(III) oxide may also decrease with the appearance of traces thereof, which, in addition to reducing the capacity and selectivity of the sorbent for lithium ions, will lead to a decrease in its chemical stability due to the dissolution of hydrated manganese(II) oxide.

The manganese (II) salt in an aqueous solution, which is used in the method, should be at concentrations in the range from 0.1 M to 2.5 M.

If this ratio is below 0.1 M, water consumption significantly increases, which is unfavorable both from environmental and economic points of view. If, on the other hand, this ratio exceeds 2.5 M, the concentration of manganese becomes lost to the value of a saturated solution. For example, suppose during synthesis, the concentration of manganese (II) sulfate reaches 3.4 M. In that case, this may lead to heterogeneity and local saturation of the solutions in the process equipment, which will lead to heterogeneity of the sorbent. The occurrence of inhomogeneities during the synthesis of the sorbent reduces its capacity and selectivity concerning lithium ions.

Furthermore, in the first step, i.e., in the step of contacting a mixture of at least one soluble manganese (II) salt in an aqueous solution and at least one aluminum

(III) salt in an aqueous solution with an alkali solution in the presence of an alkali metal permanganate, the pH of the precipitate suspension is adjusted to a value in the range of 9.0 to 12.0.

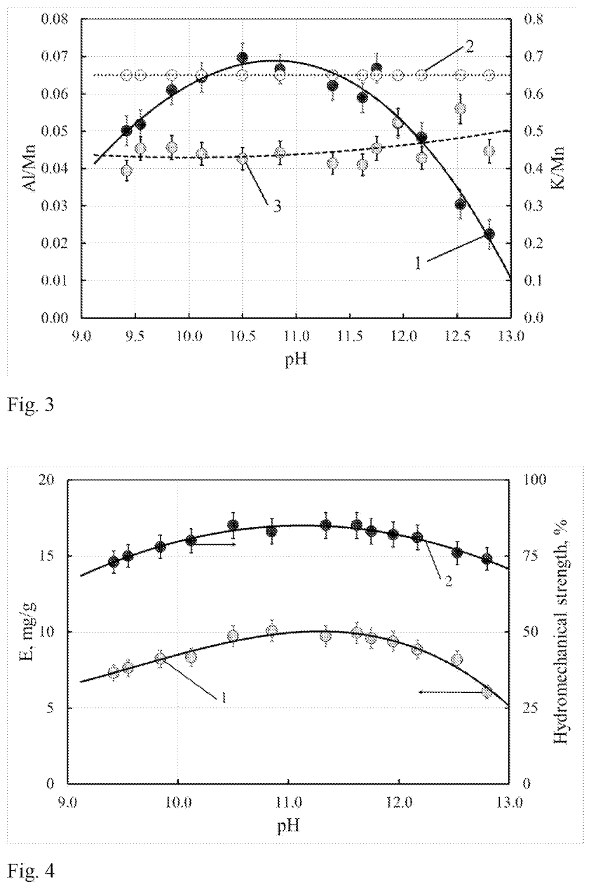

Such a range was chosen based on experiments conducted to study the dependence of the obtained molar ratios of Al₂O₃/MnOₓ (Curve 1) and K/MnOₓ (Curve 3) in the solid phase of the sorbent on the pH of the precipitated mixed hydrated manganese(III), manganese(IV), and aluminum (III) oxide shown in FIG. 3.

In addition to the experimental data mentioned above, this range was also chosen based on experiments that studied the ion-exchange capacity of the sorbent during lithium sorption from a 0.1 N LiCl solution and the hydromechanical stability of the sorbent on the pH of the precipitate shown in FIG. 4.

If the value of pH in the precipitation solution is below 9.0, this will lead to insufficient precipitation of hydrated oxides of manganese(III), manganese(IV), and aluminum (III). In addition, there will be a decrease in the amount of potassium ions, which are a part of the mixed hydrated manganese(III), manganese(IV), and aluminum (111) oxide that participate in the ion exchange reaction. Being a part of epy mixed hydrated manganese(III), manganese(IV), and aluminum (III) oxide, the potassium ions protect the hydroxyl groups of the oxide composition from condensation. Thus, a decrease in the pH of the precipitate below 9.0 leads to a decrease in the ion-exchange capacity of the synthesized sorbent. If, on the other hand, the pH value in the precipitation solution exceeds 12.0, then hydrated aluminum oxide (III) will dissolve, and this, in turn, will decrease the content of aluminum in the composition of the resulting sorbent and, accordingly, decrease in capacity and selectivity concerning lithium.

A second step of the method is washing the obtained precipitate by decanting it with deionized water to certain content of the at least one alkali metal salt in the mother solution. Content of the at least one alkali metal salt is necessary for bringing concentration to a value below 0.01 M. Exceeding this concentration will lead to a decrease in the freezing point of the mother liquor and, accordingly, to a decrease in the size of the sorbent granules obtained by freezing granulation.

In the third stage, after the completion of the washing of the precipitate by decantation, the stirring is stopped, and the precipitate is allowed to settle to the bottom of the reaction container freely. Sedimentation of the precipitate is carried out for 2 to 5 hours until the level of the precipitate in the reaction vessel reaches 50-60% of the level of the liquid phase in the reaction vessel.

Precipitation to less than 50% will require a very long deposition time, which is not technologically feasible from a practical point of view. Settling above 60% does not sufficiently concentrate the precipitate and ultimately requires the use of a more liquid phase during freezing, which is not economically advantageous.

A fourth step of the method is removing a transparent part of the mother solution to obtain a precipitate suspension in a residue of the mother solution.

A fifth step consists of transferring the obtained precipitate of the precipitate suspension in the residue of the mother solution to a freezer container (not shown) and freezing the precipitate to a solid frozen state for obtaining mixed hydrated manganese(III), manganese(IV), and aluminum (III) oxide in an icy granular form. As mentioned above, the term “hydrated mixed oxide”, e.g., of manganese(III), manganese(IV), and aluminum (III) oxide”, does not mean a mechanical mixture of hydrated manganese(III) and (IV) oxides with hydrated aluminum oxide, but rather means a chemical compound of non-stoichiometric composition.

A sixth step of the method consists of removing the at least one alkali metal salt from the surface of the icy granular form. When freezing, the salt crystals contained in the mother liquor before freezing are pushed out by the freezing waterfront to its surface. To avoid re-entering these salts into the solution after defrosting, it is necessary to remove these salts from the surface of the ice. For the removal of crystals of at least one alkali metal salt from the icy surface of frozen water, it is necessary to wash it with a stream of clean deionized water.

At the seventh step of the method, the mixed hydrated manganese(III), manganese(IV), and aluminum (III) oxide is thawed to form a resulting granulated mixed hydrated manganese(III), manganese(IV), and aluminum (III) oxide. The mother solution is also thawed to form a thawed mother solution.

At the eighth step, the icy granular form is separated from an excess of the thawed mother solution. The separation of the solid phase is carried out either by decantation or by vacuum filtration on a suction filter (Netsch filter).

The ninth step consists of converting the resulting granulated mixed hydrated manganese(III), manganese(IV), and aluminum (III) oxide into an H-form of the granulated mixed hydrated manganese(III), manganese(IV), and aluminum (III) oxide. This result is achieved by treating the latter with an acid solution. The acid is exemplified by hydrochloric acid, nitric acid, and sulfuric acid. The solution has a concentration in the range of 0.1M to 2 M. If the solution of an acid is below 0.1M, this will significantly increase water consumption, which is unfavorable from both environmental and economic points of view. If the concentration is higher than 2M, this will lead to significant losses of the sorbent due to the dissolution of its components in a solution of the corresponding acid. This factor leads to losses of the sorbent and a decrease in the yield of the finished product during synthesis. Changes that will occur in the ratio of components in the composition of granulated mixed hydrated manganese(III), manganese(IV), and aluminum (III) oxide may reduce the capacity and selectivity of the sorbent concerning lithium ions.

In the tenth step, the H-form of the granulated mixed hydrated manganese(III), manganese(IV), and aluminum (III) oxide is converted into a Li-form of the granulated mixed hydrated manganese(III), manganese(IV), and aluminum (III) oxide. This result is achieved by treating thereof with a solution of a lithium-containing compound. Examples of a lithium-containing compound suitable for the method are, e.g., a solution of lithium hydroxide LiOH and a solution of lithium carbonate Li₂CO₃.

An eleventh step is drying and calcining the Li-form of the granulated mixed hydrated manganese(III), manganese(IV), and aluminum (III) oxide for obtaining a dehydrated granulated mixed manganese(III), manganese(IV), aluminum (III) and lithium oxide, which contains in its composition four oxides and comprises a lithium-form of an inorganic ion-exchanger.

A choice of this temperature interval is based on experimental data shown in FIG. 5 is a graph illustrating the effect of heat treatment temperature on the synthesis of a material and its sorption-selective properties. In this drawing, Eoveraii is a total sorbent capacity. E_{Li} is a selective capacity for lithium during sorption from a complex solution containing 150 g/l of Na⁺ and 20 mg/l of Li⁺, E_{Na} is a capacity for sodium during sorption together with lithium from the above solution. P_{Li,Na} is a separation factor of lithium ions and sodium.

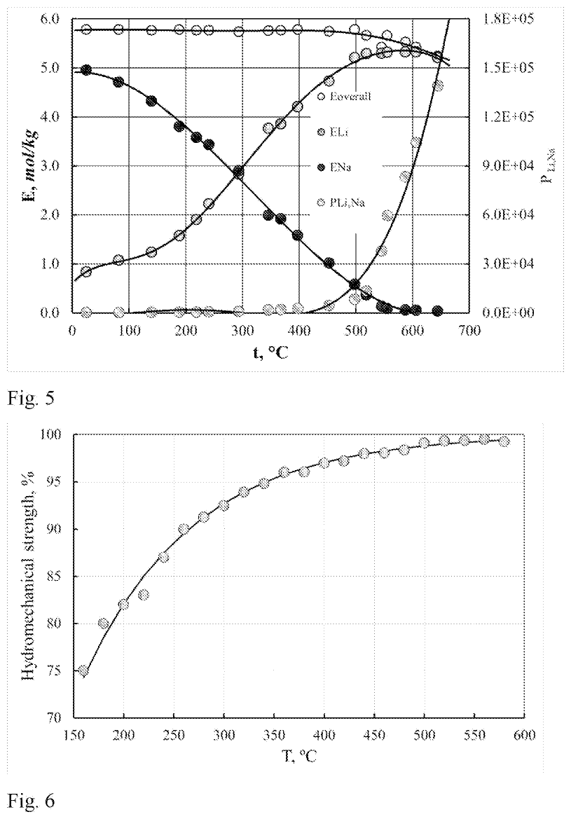

FIG. 6 shows a dependence of the hydromechanical strength of the sorbent on the heat treatment temperature. From the presented data, it can be seen that the stage of calcination of the Li-form granulated hydrated mixed oxide of manganese(III), manganese(IV), and aluminum (III) is carried out at a temperature in the range from³⁰⁰° C. to 700° C. If the heat treatment temperature is below 300° C., then the material will not achieve sufficient selectivity to lithium ions, and a sharp decrease in its hydromechanical strength will also be observed. If the heat treatment temperature is above 700° C., this will lead to destructive processes in the material, whereby the material will begin to lose its total and selective capacity for lithium.

Structural units of the synthesized sorbents are M0₆ (M=Mn(IV), Al(III)) octahedra, which can be connected to each other in various ways (vertices, edges, faces), forming chains or columns. In spaces between these chains or columns, channels are preserved that can accommodate exchange ions. The accessibility of the channels for exchange ions is determined by the shape and size of their cross sections, which can be different. The dimensions of the channel cross sections in the structure of several sorbent samples were estimated by direct experiments on the sorption of ions of various diameters (Dᵢ, pm): Li⁺—152 pm, Na⁺—194 pm, K⁺—266 pm, Rb⁺—294 pm, Cs⁺—334 pm, and also tetramethylammonium—450 pm, m-phenylenediamine—550 pm, and tetraethylammonium—700 pm (1 pm=10⁻¹² meter).

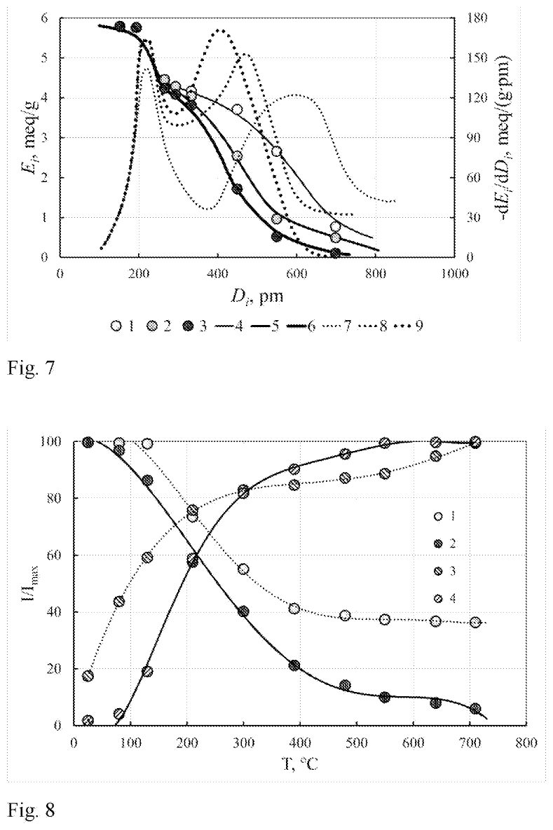

The integral and differential dependences of the exchange capacity for the synthesized materials are shown in FIG. 7, which demonstrates a clear manifestation of sieve properties in the synthesized sorbents and shows the dependence of the capacity (Ei) of the sorbent during the sorption of the corresponding ion on the ion diameter (Di) (Curves 1,2,3,4,5,6) and dependence of the sorbent capacity derivative

$$( - \frac{d {E}_{i}}{d {D}_{i}} )$$

with respect to the diameter of the ion being sorbed on the ion diameter (D,) (Curves 7,8,9). Curves 1, 4, and 7 correspond to sorbent samples prepared without drying. Curves 2, 5, and 8 correspond to sorbent samples dried at 20° C. Curves 3, 6, and 9 correspond to sorbent samples dried at 105° C.

On the curve expressing dependence of

$$( - \frac{d {E}_{i}}{d {D}_{i}} )$$

on Dᵢ for the synthesized sorbents, two main peaks can be distinguished at Dᵢ values of 230-240 and ˜600 pm (1 pm 32 10⁻¹² meter), which indicates the presence of predominantly two groups of channels in the material structure. But judging by the large width of the second peak, the group of channels corresponding to this peak is rather heterogeneous. The channels of the first group can include Li⁺ and Na⁺ ions. Larger K⁺ ions and all ions following them in size up to N(CH₃)₄⁺ ions are able to fill the channels of the second group. For an N(CH₃)₄⁺ ion, an additional drop in capacity is observed. Higher heat treatment temperatures, especially for the lithium form, make it possible to form material structures in which the crystal-chemical positions correspond only to lithium ions, and ions of other metals are not able to occupy them during the ion exchange process. Thus, the material acquires exceptional selectivity only for lithium ions.

FIG. 8 shows the dependence of the relative intensity of I/Iₘₐₓ on the heat treatment temperature, where I/Iₘₐₓ for each phase is a ratio of the intensity of one of the lines to its maximum value recorded on the X-ray patterns obtained for a sample being tested, and T is the heat treatment temperature (° C.); Curves 1 and 2 correspond to relative intensities for the birnessite phase line in the X-ray pattern with d=7.12 Å; Curves 3 and 4 correspond to relative intensities for the spinel phase line in the X-ray pattern with d=4.72 Å; Curves 1 and 3 correspond to samples with z=0.019; and Curves 2 and 4 correspond to samples with z=0.073.

According to these data, Al(III) ions contribute to the recrystallization of the birnessite phase in almost the entire temperature range. However, their effect on the spinel phase formation is more complex; they restrain the process at temperatures up to 120-150° C. and promote this process at higher temperatures. The difference in the absolute intensities of the lines is retained even in the X-ray diffraction patterns of the samples calcined at 700° C. The same effect is observed for the intensities of several other spinel lines. Thus, the Al(III) ions present in the composition of the starting material contribute to the formation of a spinel structure, which determines the selectivity of the cation exchanger concerning Li⁺ ions.

As can be seen from FIG. 8, in a Li-form, the inorganic ion exchanger contains a birnessite phase and a lithium manganese spinel phase, wherein on an X-ray pattern, the birnessite phase is characterized by a line d=7.12 Å and the lithium manganese spinel phase is characterized by line d=4.72 Å, wherein an intensity of the line d=7.12 Å of the birnessite phase does not exceed 10% of the intensity of the line d=4.72 Å of the lithium manganese spinel phase.

At the twelfth step of the method, the obtained lithium form of an inorganic ion exchanger is converted into an H-form of the ion exchanger by treating it with an acid solution. This result is achieved by treating the latter with an acid solution. The acid is exemplified by hydrochloric acid, nitric acid, and sulfuric acid. The solution has a concentration in the range of 0.1 M to 2 M. If the solution of an acid has a concentration below 0.1 M, this will greatly increase water consumption, which is unfavorable from both environmental and economic points of view. If the concentration is higher than 2 M, this will lead to significant losses of the sorbent due to the dissolution of its components in a solution of the corresponding acid. This factor also will lead to losses of the sorbent and a decrease in the yield of the finished product during synthesis. Changes in the ratio of components in the composition of the sorbent may also occur, which will reduce the capacity and selectivity of the sorbent concerning lithium ions.

The method for obtaining inorganic sorbent for lithium extraction from lithium-containing brines presented in this application makes it possible to obtain a material of the following formula: LiₓMnO_{y}·zA₂O₃. The values of “x”, “y”, “z”, their interdependence, and ranges were described above.

The composition of the sorbent in the ion-exchange H-form prepared for the sorption of lithium has the following form: HₓMnO_{y}·zAl₂O₃·nH₂O. In this case, the parameters “x”, “y” and “z” have the same values as in the case of the original Li-form. The parameter “n” is an uncontrolled parameter, and its value is determined by the hydration of the material and depends on the parameter “x” and the conditions of material synthesis. The value of the parameter “n” depends on the drying conditions of the material samples in the H-form before measuring the water content in the material. Typically, the water content in the H-form of the sorbent is determined after drying the material at room temperature and atmospheric pressure to constant weight.

The conversion process of this stage is carried out by treating the obtained lithium form of an inorganic ion exchanger with an acid solution in an ion-exchange column having a head and a bottom with a supply of the solution of a lithium-containing compound to the head or the bottom of the column with a flow of the solution through the column at a linear speed in the range from 1 to 100 mm/min and until the release of lithium ions into the acid solution ceases.

If the flow speed is below 1 mm/min, such a speed is not economically and technologically feasible, which extends the processing time. If the speed exceeds 100 mm/min, it would be difficult to realize such a speed due to the high hydrodynamic resistance of the sorbent layer. Increased pressure may be required to force the solution through the sorbent layer, and technological equipment capable of working at such increased pressure may be needed for performing such a process. Also, high flow rates of solutions through the sorbent layer will cause rapid hydromechanical destruction of the sorbent

### Equipment and Procedures Used in the Method of the Invention

### Ion-Exchange Column

The ion-exchange column used in the invention method was a standard chromatographic column with a diameter of up to 10 mm. The height of the sorbent layer was maintained in the range of 10 to 30 column diameters. The solution was fed through the column at a constant linear speed in the range of 1 to 10 mm/s. The feed rate of the solution was maintained by means of a peristaltic pump. During sorption experiments, special measures were taken to prevent air from entering the sorbent layer and partially dry the sorbent granules.

### Determination of the Content of Lithium

The emission photometry of a flame carried out the determination of lithium in solutions. The most intense resonance line in the spectrum of lithium, 670.8 nm, was used for the analysis. This line corresponds to the transition between the energy levels 2²S_{1/2} and 2²P⁰_{3/2} at the excitation energy of 1.85 eV. The method's sensitivity in determining lithium (with the FLAME PHOTOMETER, FP8000 series device; A.KRÜSS Optronic) was 0.001-0.0005 μg Li/ml. The lithium content was determined from the calibration based on reference solutions prepared based on pure metal salts and their mixtures present in the solutions under study, which were close in proportion to the test solutions. Determination of sodium content was carried out similarly.

### Determination of the Content of Aluminum and Total Manganese

X-ray fluorescence spectroscopy was determined by the content of aluminum and manganese in the composition of the investigated sorbent samples. The experiments were performed on a VRA-30 spectrometer. The excitation source was a tube with a tungsten anode, operating at U=40 kV, I=30 mA. Pentaerythritol or LiF single crystals were used as the analyzer crystals. The registration was carried out using a proportional counter.

Determination of the content of aluminum was carried out along the line K_{α}; the method's sensitivity was 0.005%. The total manganese content was determined along the line K_{α}; the method's sensitivity was 0.02%. The background in the analysis was considered by the method of linear interpolation and by using a blank sample. Samples of materials for X-ray fluorescence analysis were prepared by compressing them in the form of tablets with NaCl (S7653 SIGMA-ALDRICH >99.5% (AT)) at a pressure of 4000 kg/cm². The instrument was calibrated using samples containing fixed amounts of manganese (II) oxide (431761 SIGMA-ALDRICH 99.99% trace metals basis) and aluminum oxide (229423 SIGMA-ALDRICH 99.99% trace metals basis).

### Determination of the Content of Manganese

The content of Mn (II, III, IV) in the oxides was determined by dissolving a substance sample in a known volume of a titrated solution of oxalic acid in the presence of sulfuric acid. The atomic absorption method of analysis was used to determine the general content of manganese in solutions. A line of 279.4 nm characteristic for this element was used to determine the content of manganese.

The analysis was performed using an air-acetylene flame. The sensitivity of the method was 0.15 mg/ml. Li, Na, and Al had no effect on the determination of manganese. Because inorganic acids impact the determination of manganese, the acid content in the analyzed solution was reduced to a fixed value before the analysis, and nitric acid was used as the acid having the least effect.

### Sorption-Selective Parameters

The following characteristics were taken as parameters describing sorption-selective properties: a total exchange capacitance E_{Li}, obtained by using 0.1 N LiOH solution as a sorbent; a selective lithium capacitance E_{Li} used for sorption from a solution of lithium and sodium salts at an ionic ratio Li⁺:Na⁺ of 1/10 at pH=12; and a coefficient P_{Li,Na} of selectivity of the sorbent concerning lithium, which is a direct parameter that characterizes separation of lithium from sodium and which is represented by the following formula:

$${P}_{L i , N a} = \frac{{E}_{Li 1} \cdot {C}_{N a}}{{E}_{N a 1} \cdot {C}_{L i}}$$

Where E_{Li1} is a selective lithium capacity at sorption from a solution of lithium and sodium salts at ionic ratio Li⁺/Na⁺ of 1/10 at pH=12 (mol/kg sorb.);

E_{Na1} is a sodium capacity at sorption from a solution of lithium and sodium salts at ionic ratio Li⁺/Na⁺ of 1/10 at pH=12 (mol/kg sorb.);

C_{Li} is a molar concentration of Li⁺ in a solution of lithium and sodium salts at ionic ratio Li⁺/Na⁺ of 1/10 at pH=12 (mol/l);

C_{Na} is a molar concentration of Na⁺ in a solution of lithium and sodium salts at ionic ratio Li⁺/Na⁺ of 1/10, pH=12 (mol/l).

### Hydromechanical Strength of the Sorbent

Hydromechanical strength (HMS) of the sorbents was determined as follows: a sample of an air-dry sorbent weighing 1.00±0.01 g with a granule size of 0.25-1.0 mm was continuously mixed with 20 mL of water for 24 hours. Then the sorbent was quantitatively transferred to a sieve with a mesh size of 0.25 mm; the sorbent granules were thoroughly washed with water and dried at 100° C. to constant weight. After cooling to room temperature, the sorbent was weighed on an analytical balance with an accuracy of 0.01 g. The HMS value, expressed as a percentage, was calculated by the formula:

$$HMS = \frac{{m}_{e n d}}{{m}_{0}} \cdot 100 \%$$

Where m_{end} is the mass of the sorbent after mixing, and m₀ is the mass of the sorbent before mixing.

### EXAMPLES

### Example 1

The starting material for the Li-selective ion exchanger was Mn(OH)₂. The coagulum of Mn(OH)₂ was precipitated by reacting a 1M solution of MnSO₄ with a NaOH solution. During the synthesis, an additive of the calculated amount of Al₂(SO 4)₃ was introduced into the MnSO₄ solution. The Mn(OH)₂ coagulum with the addition of Al(OH)₃ was obtained as a paste. Simultaneously with the NaOH solution, potassium permanganate KMnO₄ was added to the reaction mixture. Potassium permanganate was taken in an amount close to the stoichiometry for the oxidation reaction. As a result, a hydrated manganese oxide with an average oxidation degree of manganese of 3.1 to 3.3 was produced. After oxidation of the paste with potassium permanganate, the final pH of the paste was in the range of 10.7 to 10.9. The precipitate was washed by decanting with deionized water to contain the amount of sodium and potassium salts in the mother solution to a value not exceeding 9.8 mg/l. The transparent part of the mother solution was removed to obtain a precipitate suspension in a residue of the mother solution. The resulting precipitate was transferred to a freezing container and placed in a freezer, where it was frozen at −5° C. Before defrosting, salt crystals precipitated on the ice surface were removed by washing with a stream of deionized water. After thawing, a granulate with a particle size of 0.1 to 1.0 mm was obtained.

The granules yield was 134 g per 1.0 mol of manganese sulfate; the yield recalculated for the anhydrous product was—99.1 g. The bulk density of the dried granules with a particle size <1 mm was in the range of 0.94 g/cm³ to 1.06 g/cm³.

The obtained granules were loaded into an ion exchange column, where they were treated with 0.5 mol/l LiOH solution to saturate Li⁺ ions. The column size provided the necessary capacity for the used quantity of dried and crushed paste granules. A ratio between the height of the layer of material in the column and its diameter L/D was in the range: of L/D≥10 to 15.

After this operation, the material was discharged from the ion-exchange column and placed on a filter cloth to release free moisture and dry the obtained substance. The material could also be freed of moisture by placing it on a vacuum suction filter. Drying was conducted in the air for 1 to 2 days or when heated to a temperature in the range of 90 to 95° C. for 3 to 4 hours.

The air-dried material was calcined at a temperature of 450 to 550° C. (optimally 480° C.) for 4 to 6 hours. The material obtained after cooling was a Li-form sorbent., The yield of the sorbent in the Li-form per 1 mol of manganese sulfate was 98.3 g.

The sorbent was stored in a Li-form in a dry state. Before use, it was soaked in water and loaded into an ion exchange column for conversion into an H-form by treating under dynamic conditions with a solution of 0.3 to 0.5 mol/l HNO₃.

The sorbent was tested by extracting lithium from a solution (dynamic conditions) with the following composition: (g/l): LiCl—0.121; NaCl—150. The ionic ratio of Li⁺/Na⁺ was 1:900.

Under conditions of saturation of the cation exchanger with Li⁺, the process of sorption was characterized by the exchange capacity E_{Li}=2.3 mol/kg and the separation factor K_{Li,Na}=4.2·10⁵. Desorption of lithium from the cation exchanger proceeded easily and completely under the action of 0.3 to 0.5 mol/l solution of HNO₃. The loss of the sorbent, according to the results of its tests for 12 cycles in the ion exchange column, amounted to an average of not more than 0.5-0.8% per cycle.

### Example 2

The starting material for the Li-selective ion exchanger was Mn(OH)₂. The coagulum of Mn(OH)₂ was precipitated by reacting a 1M solutions of MnCl₂ with a NaOH solution. During the synthesis, an additive of the calculated amount of AlCl₃ was introduced into the MnCl₂ solution. The Mn(OH)₂ coagulum with the addition of Al(OH)₃ was obtained as a paste. Simultaneously with the KOH solution, potassium permanganate KMnO4 was added to the reaction mixture. Potassium permanganate was taken in an amount close to the stoichiometry for the oxidation reaction. As a result, a hydrated manganese oxide with an average oxidation degree of manganese of 3.1 to 3.3 was produced. After oxidation of the paste with manganese permanganate, the final pH of the paste was in the range of 11.5 to 11.9. The precipitate was washed by decanting with deionized water to bring the content of sodium and potassium salts in the mother solution to a value not exceeding 10.1 mg/l. The transparent part of the mother solution was removed to obtain a precipitate suspension in a residue of the mother solution.

The resulting precipitate was transferred to a freezing container and placed in a freezer, where it was frozen at −6° C. Before defrosting, salt crystals precipitated on the ice surface were removed by washing with a stream of deionized water. After thawing, a granulate with a particle size of 0.1 to 1.0 mm was obtained.

The granules yield per 1 mol of manganese chloride was 132 g; the yield recalculated for an anhydrous product was 97.8 g. The bulk density of the dried granules with a particle size <1 mm was about 0.94 to 1.06 g/cm³.

The obtained granules were loaded into an ion exchange column, where they were treated with a 0.5 mol/l LiOH solution to saturate Li⁺ ions. This process was conducted similarly to the one described in Example 1.

After this operation, the material was discharged from the ion-exchange column and placed on a filter cloth to release free moisture and dry the obtained substance. The material could also be freed of moisture by placing it on a vacuum suction filter. Drying was conducted in the air for 1 to 2 days or by heating to a temperature in the range of 90 to 95° C. for 3 to 4 hours.

The air-dried material was calcined at a temperature of 500 to 550° C. for 4 to-6 hours. The material obtained after cooling was a Li-form sorbent. The yield of the sorbent in the Li-form per 1 mol of manganese sulfate was 99.7 g.

The sorbent was stored in a Li-form in a dry state. Before use, it was soaked in water and loaded into an ion exchange column for conversion into an H-form by treating under dynamic conditions with a solution of 0.15 to 0.25 mol/l of H₂SO₄.

The material obtained after cooling was a Li-form sorbent. The yield of the sorbent in the Li-form per 1 mol of manganese sulfate was 101.9 g.

Testing of the sorbent was carried out by extracting lithium from a solution (dynamic conditions) having the following composition: (kg/m³): LiCl—0.121; NaCl—150, MgCl₂—9.5, CaCl₂—6.0, KCl—4.0, KBr—0.2, KI—0.1, NaHCO₃—0.2. The ionic ratio of Li⁺/Na⁺ was 1:900.

Under conditions of saturation of the cation exchanger with Li⁺, the process of sorption was characterized by the exchange capacity E_{Li}=2.3 mol/kg and the separation factor K_{LiNa}=5.2·10⁵. Desorption of lithium from the cation exchanger proceeded easily and completely under the action of 0.3 to 0.5 rnol/lsolution of HNO₃. According to the results of its tests for 12 cycles in the ion exchange column, the loss of the sorbent amounted to an average of not more than 0.3-0.4% per cycle.

### Example 3

Similar to the previous examples, the coagulum of Mn(OH)₂ was precipitated by reacting a 1M solutions of MnAc₂ with a NaOH solution. During the synthesis, an additive of the calculated amount of Al(Ac)₃ was introduced into the MnAc₂ solution. The Mn(OH)₂ coagulum with the addition of Al(OH)₃ was obtained as a paste. Simultaneously with the KOH solution, potassium permanganate KMnO₄ was added to the reaction mixture. Potassium permanganate was taken in an amount close to the stoichiometry for the oxidation reaction. As a result, a hydrated manganese oxide with an average oxidation degree of manganese of 3.1 to 3.3 was produced. After oxidation of the paste with potassium permanganate, the final pH of the paste was in the range of 11.5 to 11.9. The precipitate was washed by decanting with deionized water to contain the amount of sodium and potassium salts in the mother solution to a value not exceeding 9.5 mg/l. The transparent part of the mother solution was removed to obtain a precipitate suspension in a residue of the mother solution. The resulting precipitate was transferred to a freezing container and placed in a freezer, where it was frozen at −7° C. Before defrosting, salt crystals precipitated on the ice surface were removed by washing with a stream of deionized water. After thawing, a granulate with a particle size of 0.1 to 1.0 mm was obtained.

Per 1 mol of manganese acetate, the yield of the dried paste was 141.0 g; the anhydrous substance yield was 100.1 g. The bulk density of the dried paste, with a particle size of <1 mm, was in the range of 0.94 to 1.06 g/cm³.

The obtained granules were loaded into an ion exchange column, where they were treated with a 0.5M LiOH solution to saturate Li⁺ ions. This process and the subsequent drying were performed in the same manner as in Example 1.

The air-dried material was calcined at a temperature of 450 to 500° C. for 4 to 6 hours. The material obtained after cooling was a Li-form sorbent. The yield of the sorbent in the Li-form per 1 mol of manganese sulfate was 100.9 g.

The sorbent was stored in a Li-form in a dry state. Before use, it was soaked in water and loaded into an ion exchange column for conversion into an H-form by treating under dynamic conditions with a solution of 0.3 to 0.5 mol/l of HNO₃.

The material obtained after cooling was a Li-form sorbent. The yield of the sorbent in the Li-form per 1 mol of manganese sulfate was 101.9 g.

Testing of the sorbent was carried out by extracting lithium from a solution (dynamic conditions) having the following composition: (kg/m³): LiCl—0.121; NaCl—150, MgCl₂—9.5, CaCl₂—6.0, KCl—4.0, KBr—0.2, KI—0.1, NaHCO₃—0.2. The ionic ratio of Li⁺/Na⁺ was 1:900.

Under conditions of saturation of the cation exchanger with Li⁺, the process of sorption was characterized by the exchange capacity E_{Li}=2.3 mol/kg and the separation factor K_{Li,Na}=4.8·10⁵. Desorption of lithium from the cation exchanger proceeded easily and completely under the action of a 0.3 to 0.5 mol/l solution of HNO₃. According to the results of its tests for 10 cycles in the ion exchange column, the loss of the sorbent amounted to an average of not more than 0.3-0.5% per cycle.

Operation conditions and parameters used in other examples are summarized in Tables 2 and 3. These tables present the results of tests of sorbents obtained under different conditions of synthesis but within the framework of the present invention. The ion exchange test used a solution of the following composition (kg/m³): LiCl—0.121; NaCl—150. The ionic ratio of Li⁺/Na⁺ was 1:900 (pH=6.1).

TABLE 2
Operation conditions and parameters used in the process

| Sample No. | Amount of added aluminum oxide $\frac{{Al}_{2} {O}_{3}}{{MnO}_{x}}$ | Selective capacity for Li⁺, (E_{Li}, mol/kg) | Coefficient of separation of ions of Li⁺ and Na⁺, (P_{Li,} Na) | The average degree of Mn oxidation | Synthesis tempera- ture, ° C. |
|---|---|---|---|---|---|
| 1 | 0.000 | 0.85 | 1.4·10⁴ | 2.8 | 650 |
| 2 | 0.019 | 0.91 | 4.2·10⁴ | 3.2 | 600 |
| 3 | 0.035 | 1.05 | 9.2·10⁴ | 3.3 | 550 |
| 4 | 0.050 | 1.34 | 1.8·10⁵ | 3.4 | 500 |
| 5 | 0.061 | 1.95 | 2.7·10⁵ | 3.6 | 450 |
| 6 | 0.073 | 2.22 | 3.4·10⁵ | 3.2 | 450 |
| 7 | 0.085 | 2.18 | 2.3·10⁵ | 3.2 | 450 |
| 8 | 0.100 | 1.76 | 1.4·10⁵ | 3.4 | 450 |
| 9 | 0.129 | 1.25 | 5.6·10⁴ | 3.3 | 450 |
| 10 | 0.153 | 0.98 | 4.4·10⁴ | 3.6 | 450 |
| 11 | 0.180 | 0.76 | 3.2·10⁴ | 3.5 | 400 |
| 12 | 0.212 | 0.72 | 2.8·10⁴ | 3.6 | 350 |
| 13 | 0.250 | 0.68 | 2.5·10⁴ | 3.8 | 300 |
| 14 | 0.300 | 0.57 | 1.1·10³ | 3.85 | 250 |

TABLE 3
Other operation conditions and parameters used in the process

| Sample No. | Amount of added aluminum oxide $\frac{{Al}_{2} {O}_{3}}{{MnO}_{x}}$ | Selective capacity for Li⁺, (E_{Li}, mol/kg) | Coefficient of separation of ions of Li⁺ and Na⁺, (P_{Li, Na}) | The average degree of Mn oxidation | Synthesis tempera- ture, ° C. |
|---|---|---|---|---|---|
| 1 | 0.075 | 3.1 | 9.5·10² | 3.6 | 295 |
| 2 | 0.075 | 3.9 | 1.7·10³ | 3.5 | 345 |
| 3 | 0.075 | 4.3 | 2.0·10³ | 3.4 | 368 |
| 4 | 0.075 | 4.5 | 2.6·10³ | 3.5 | 400 |
| 5 | 0.075 | 5.0 | 4.5·10³ | 3.6 | 450 |
| 6 | 0.075 | 5.2 | 8.2·10³ | 3.5 | 500 |
| 7 | 0.075 | 5.3 | 1.3·10⁴ | 3.4 | 520 |
| 9 | 0.075 | 5.3 | 3.7·10⁴ | 3.2 | 545 |
| 9 | 0.075 | 5.2 | 8.3·10⁴ | 3.1 | 590 |
| 10 | 0.075 | 5.324 | 1.04·10⁵ | 3.0 | 610 |
| 11 | 0.075 | 5.324 | 1.40·10⁵ | 2.9 | 645 |

As can be seen from the tables, the results of testing of samples that were prepared within the scope of the invention served the purposes of the invention. On the other hand, the samples that were beyond the scope could not provide the effects of the invention.

It can be seen that the inorganic ion-exchanger of the invention has a total ion exchange capacity of at least 3.1 meq/g and a selective ion-exchange capacity, specifically to lithium of at least 2.9 meq/g.

The average degree of manganese oxidation has a value in the range of 2.9 to 3.8, and the coefficient of separation of ions of Li⁺ and Na⁺ (P_{Li,Na}) has a value in the range of 9.5·10² to 3.4·10⁵.

The technical and economic advantages of this method in comparison with the prior-art method were the following:
a)—increase in the sorption capacity of the sorbent for lithium by 2.7 times and in selectivity for lithium by 25 times, and
b) 10-15% improvement in the operating properties of the sorbent by reducing its losses in repeated cycles of sorption and desorption due to an increase in hydromechanical strength.

Thus, it has been shown that the sorbent obtained by the invention method is suitable for industrial lithium production by extraction from complex natural and technological brines.

### Example 4

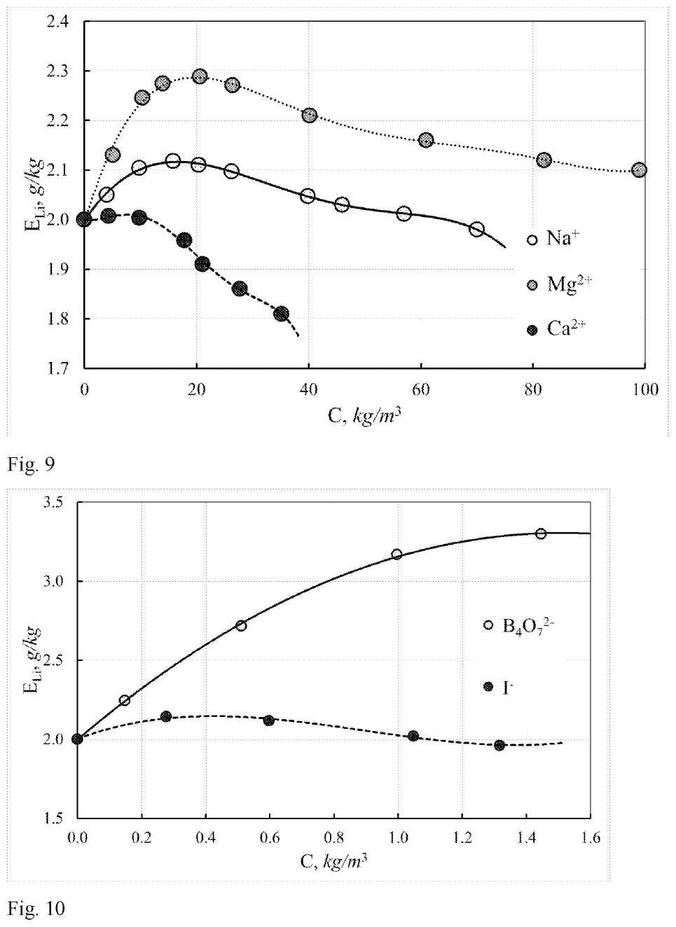

The sorbent obtained in accordance with the present invention under optimal conditions was tested in the process of extracting lithium from a natural brine, in which the content of the corresponding metal cations and some anions was adjusted. The results of testing the sorbent are shown in FIGS. 9 and 10. FIG. 9 shows that the content of sodium ions in the solution practically does not affect the selective capacity of the sorbent with respect to lithium ions Lit However, calcium ions have a negative effect on lithium sorption. In contrast, magnesium ions have a positive effect on the capacity of the ion exchanger with respect to lithium ions.

FIG. 10 shows that the presence of iodine ions has practically no effect on lithium sorption. However, the presence of even small amounts of boron in the solution has a very strong positive effect on the sorption of lithium, increasing its selective capacity.

The inorganic sorbents for extracting lithium from natural and technological brines and the illustrative method suitable for obtaining the inorganic sorbent were described concerning specific examples of compositions and technological steps. It is understood, however, that these compositions and process steps were given only as examples and that any changes and modifications are possible within the scope of the attached patent claims. For example, the units of the synthesis equipment may vary depending on specific conditions. The brines may be taken from different sources. The sorbents obtained by the method of the invention may find different applications, and the synthesis of the sorbents can be conducted at different temperatures selected according to specific conditions. Various acids can be used in the method.

1. An inorganic ion-exchanger in the form of solid particles comprising a chemical non-stoichiometric compound in the form of an inorganic polymeric aqua-oxo-hydroxo complex intended for selective extraction of lithium from lithium-containing natural and industrial brines, the inorganic ion-exchanger being represented by the following general formula:
HₓMnO_{y}·zAl₂O₃·nH₂O;
wherein:
“x” is a number ranging from 0.5 to 2.0,
“y” is a number ranging from 2.0 to 3.0,
“z” is a number ranging from 0.01 to 0.1, and
“n” is a number ranging from 1.0 to 2.0.

2. The inorganic ion-exchanger, according to claim 1, wherein the polymeric aqua-oxo-hydroxo complex is a polymeric aqua-oxo-hydroxo complex of manganese(III), manganese(IV), and aluminum.

3. The inorganic ion-exchanger, according to claim 2, wherein the polymeric aqua-oxo-hydroxo complex of manganese(III), manganese(IV), and aluminum is a mixed polynuclear complex.

4. The inorganic ion exchanger according to claim 3, wherein in a Li-form the inorganic ion exchanger comprises a birnessite phase and a lithium manganese spinel phase, wherein on a X-ray pattern the birnessite phase is characterized by a line d=7.12 Å, the lithium manganese spinel phase is characterized by a line d=4.72 Å, and an intensity of the line d=7.12 Å of the birnessite phase does not exceed 10% of the intensity of the line d=4.72 Å of the lithium manganese spinel phase.

5. The inorganic ion-exchanger, according to claim 1, which has a total ion exchange capacity of at least 3.1 meq/g and a selective ion-exchange capacity specifically to lithium of at least 2.9 meq/g.

6. The inorganic ion-exchanger, according to claim 3, which has a total ion exchange capacity of at least 3.1 meq/g and a selective ion-exchange capacity specifically to lithium of at least 2.9 meq/g.

7. The inorganic ion-exchanger, according to claim 4, which has a total ion exchange capacity of at least 3.1 meq/g and an ion-exchange capacity specifically to lithium of at least 2.9 meq/g.

8. The inorganic ion-exchanger of claim 1, wherein the solid particles have dimensions in the range of 0.1 to 2.0 mm.

9. The inorganic ion-exchanger of claim 3, wherein the solid particles have dimensions in the range of 0.1 to 2.0 mm.

10. The inorganic ion-exchanger of claim 4, wherein the solid particles have dimensions in the range of 0.1 to 2.0 mm.

11. The inorganic ion-exchanger of claim 1, wherein the average degree of manganese oxidation has a value in the range of 2.9 to 3.8.

12. The inorganic ion-exchanger of claim 1, wherein the coefficient of separation of ions of Li⁺ and Na⁺ (P_{Li,Na}) has a value in the range of 9.5·10² to 3.4·10⁵.

13. The inorganic ion-exchanger of claim 3, wherein the average degree of manganese oxidation has a value in the range of 2.9 to 3.8 and the coefficient of separation of ions of Li⁺ and Na⁺ (P_{Li,Na}) has a value in the range of 9.5·10² to 3.4·10⁵.

14. The inorganic ion-exchanger of claim 4, wherein the average degree of manganese oxidation has a value in the range of 2.9 to 3.8 and the coefficient of separation of ions of Li⁺ and Na⁺ (P_{Li,Na}) has a value in the range of 9.5·10² to 3.4·10⁵.

15. The inorganic ion-exchanger of claim 7, wherein the average degree of manganese oxidation has a value in the range of 2.9 to 3.8 and the coefficient of separation of ions of Li⁺ and Na⁺ (P_{Li,Na}) has a value in the range of 9.5·10² to 3.4·10⁵.

16. The inorganic ion-exchanger of claim 8, wherein the average degree of manganese oxidation has a value in the range of 2.9 to 3.8 and the coefficient of separation of ions of Li⁺ and Na⁺ (P_{Li,Na}) has a value in the range of 9.5·10² to 3.4·10⁵.
